(19) United States
(12) Patent Application Publication
(10) Pub. No.: US 2009/0170559 A1
(43) Pub. Date: Jul. 2, 2009

(54) MOBILE TELEPHONE WITH TWO ANTENNAS FOR USE IN CONTACTLESS PAYMENTS

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 12/028,299

(22) Filed: Feb. 8, 2008

Related U.S. Application Data
(60) Provisional application No. 61/016,872, filed on Dec. 27, 2007.

(51) Int. Cl. H04M 1/00

(52) U.S. Cl. 455/556.1

(57) ABSTRACT

A mobile telephone includes conventional features such as a housing, a speaker, a microphone, an antenna by which voice signals are transmitted and received, and electronic circuitry which handles the sending and receiving of voice signals. The mobile telephone includes two more antennas, one adjacent the front surface of the housing, and the other adjacent the rear surface of the housing. In addition, the mobile telephone includes a payment circuit that is mounted in the housing and coupled to the latter two antennas. The payment circuit is operative to selectively receive a customer's payment card account number via one or both of the latter two antennas.

### CROSS-REFERENCE TO RELATED APPLICATIONS

The present application claiming the benefit U.S. Provisional Application No. 61/016,872 filed Dec. 27, 2007 and entitled “MOBILE TELEPHONE WITH TWO ANTENNAS FOR USE IN CONTACTLESS PAYMENTS”, which is incorporated herein by reference.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

In pursuit of still greater convenience and more rapid transactions at POS terminals, payment cards have more recently been developed that allow the account number to be automatically read from the card by radio frequency communication between the card and a so-called “proximity reader” which may be incorporated with the POS terminal. In such cards, often referred to as “proximity payment cards” or “contactless payment cards”, a radio frequency identification (RFID) integrated circuit (IC, often referred to as a “chip”) is embedded in the card body. A suitable antenna is also embedded in the card body and is connected to the RFID chip to allow the chip to receive and transmit data by RF communication via the antenna. In typical arrangements, the RFID chip is powered from an interrogation signal that is transmitted by the proximity reader and received by the card antenna.

MasterCard International Incorporated, the assignee hereof, has established a widely-used standard, known as “PayPass”, for interoperability of contactless payment cards and proximity readers.

It has been proposed that the capabilities of a contactless payment card be incorporated into a mobile telephone, thereby turning the mobile telephone into a contactless payment device. Typically a mobile telephone/contactless payment device includes integrated circuitry with the same functionality as the RFID IC of a contactless payment card. In addition, the mobile telephone/contactless payment device includes a loop antenna that is coupled to the payment-related IC for use in sending and/or receiving messages in connection with a transaction that involves contactless payment.

Conventionally, a contactless payment occurs when a contactless payment card or device is presented to a proximity reader that is associated with a point of sale terminal. However, proposals have also been made concerning “mobile-to-mobile” contactless payments utilizing conventional payment systems. In the latter type of transaction, a customer presents his mobile telephone/contactless payment device to another mobile device (e.g., also a mobile telephone) that is held by a merchant, such as a flea market seller, itinerant merchant, taxi driver, etc. The merchant's mobile device plays the part of the proximity reader, and receives the customer's payment card account number from the customer's device via wireless communication. The merchant's mobile device then initiates an authorization request for a purchase transaction to an acquirer financial institution that is part of a conventional payment system. The merchant's mobile device may do so by using the conventional mobile telephone network. After the payment system routes the authorization request to the financial institution that issued the customer's payment card account, a response to the authorization request is returned to the merchant's mobile device, and the transaction may be consummated in a similar manner to a transaction that occurs via contactless payment at a POS terminal.

It has also been proposed that a merchant's mobile device, as referred to in the preceding paragraph, also function as a contactless payment device, to allow the merchant to use the mobile device to access the merchant's payment card account for purchases that the merchant desires to make.

The present inventor has recognized that the antenna configurations previously proposed for mobile telephone/contactless payment devices are not versatile enough for convenient use in all of the various types of transactions that the holders of such devices may wish to enter into.

### BRIEF DESCRIPTION OF THE DRAWINGS

FIG. 1 is a schematic block diagram of a mobile telephone/contactless payment device according to some embodiments.

FIGS. 2 and 3 are respectively a front isometric view and a rear isometric view of the mobile telephone/contactless payment device of FIG. 1, and respectively also indicate the loci in the mobile telephone/contactless payment device of a front side antenna and a rear side antenna which may be used for contactless payments.

FIG. 4 is a schematic cross-sectional view showing some of the salient components of the mobile telephone/contactless payment device of FIGS. 1-3.

FIG. 5 is a schematic block diagram of an alternative embodiment of the mobile telephone/contactless payment device.

FIG. 6 is a flow chart that illustrates a process that may be performed in the mobile telephone/contactless payment device of FIG. 5.

### DETAILED DESCRIPTION

In general, and for the purpose of introducing concepts of embodiments of the present invention, a mobile telephone/contactless payment device includes both a front antenna and a rear antenna, either of which may be suitable for use in contactless payments, and both coupled to the payment circuitry included in the mobile telephone/contactless payment device.

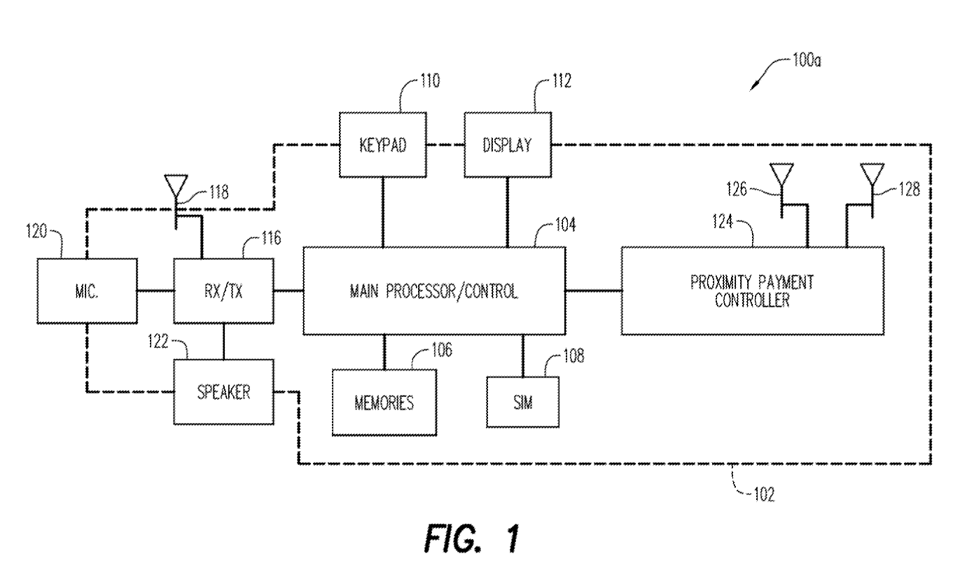

FIG. 1 is a schematic block diagram of an example embodiment of a mobile telephone/contactless payment device 100. (FIG. 1 does not necessarily represent the physical layout of the mobile telephone/contactless payment device 100.) In its active circuitry, in its user interface, and in its software/firmware, the mobile telephone/contactless payment device 100 may be entirely conventional.

The mobile telephone/contactless payment device 100 may include a conventional housing (indicated by dashed line 102 in FIG. 1) that contains and/or supports the other components of the mobile telephone/contactless payment device 100. The mobile telephone 102 further includes conventional control circuitry 104, for controlling over-all operation of the mobile telephone/contactless payment device 100. Other components of the mobile telephone/contactless payment device 100, which are in communication with and/or controlled by the control circuitry 104, include: (a) one or more memory devices 106 (e.g., program and working memory, etc.); (b) a conventional SIM (subscriber identification module) card 108; (c) a conventional keypad 110 for receiving user input; and (d) a conventional display 112 for displaying output information to the user.

The mobile telephone/contactless payment device 100 also includes conventional receive/transmit circuitry 116 that is also in communication with and/or controlled by the control circuitry 104. The receive/transmit circuitry 116 is coupled to an antenna 118 and provides the communication channel(s) by which the mobile telephone/contactless payment device 100 communicates via the mobile network (not shown). The mobile telephone/contactless payment device 100 further includes a conventional microphone 120, coupled to the receive/transmit circuitry 116. Of course, the microphone 120 is for receiving voice input from the user. In addition, a loudspeaker 122 is included to provide sound output to the user, and is coupled to the receive/transmit circuitry 116.

In conventional fashion, the receive/transmit circuitry 116 operates to transmit, via the antenna 118, voice signals generated by the microphone 120, and operates to reproduce, via the loudspeaker 122, voice signals received via the antenna 118. The receive/transmit circuitry 116 may also handle transmission and reception of text messages and/or other data communications via the antenna 118.

The mobile telephone/contactless payment device 100 may also include an integrated circuit (IC) or chipset 124 of the kind embedded in contactless payment cards. The IC/chipset 124 may also be referred to as a “payment circuit”. The payment circuit 124 may store a payment card account number that identifies a payment card account that has been issued to the individual who owns the mobile telephone/contactless payment device 100. In addition, or alternatively, the payment circuit 124 may provide functionality that allows the mobile telephone/contactless payment device 100 to receive payment card account numbers from customers' contactless payment devices and to initiate authorization requests for purchase transactions, so that the mobile telephone/contactless payment device 100 may function as a merchant's device in a payment system. Further, and in accordance with aspects of the present invention, the mobile telephone/contactless payment device 100 may include loop antennas 126 and 128, both coupled to the payment circuit 124. (Details of example embodiments of the loop antennas 126, 128 will be provided below.) The payment circuit 124 may operate so as to interact with an RFID/NFC proximity reader of a POS terminal to provide the payment card account number (stored in the payment circuit 124) for a purchase transaction at the POS terminal. For example, the payment circuit 124 may be designed/programmed to operate in accordance with the above-mentioned “PayPass” standard. Moreover, the payment circuit 124 may operate to allow the mobile telephone/contactless payment device 100 to participate in mobile-to-mobile payments.

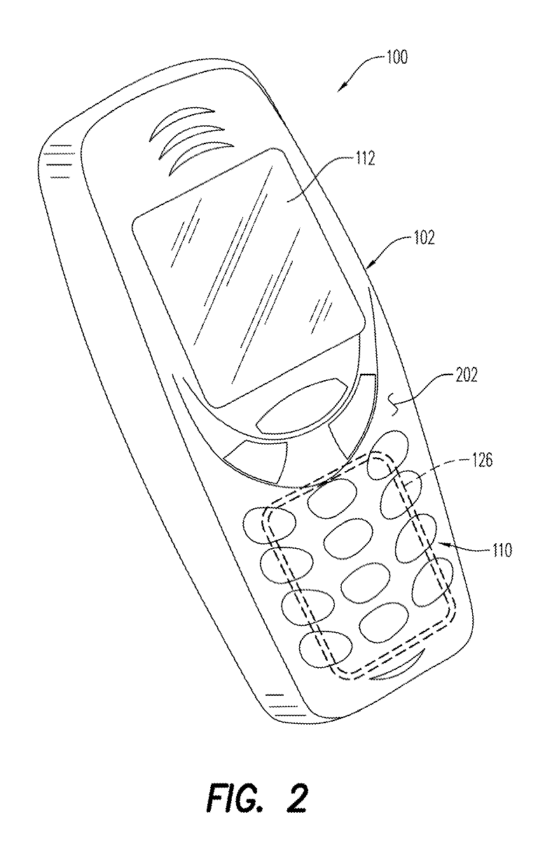

FIG. 2 is an isometric front view of the mobile telephone/contactless payment device 100, showing the locus of the antenna 126. The antenna 126 is adjacent the front surface 202 of the housing 102 of the mobile telephone/contactless payment device 100; accordingly, the antenna 126 may be referred to as the “front side antenna”. Also seen in FIG. 2 are the above-mentioned keypad 110 and display 112, both mounted at the front surface 202 of the housing 102.

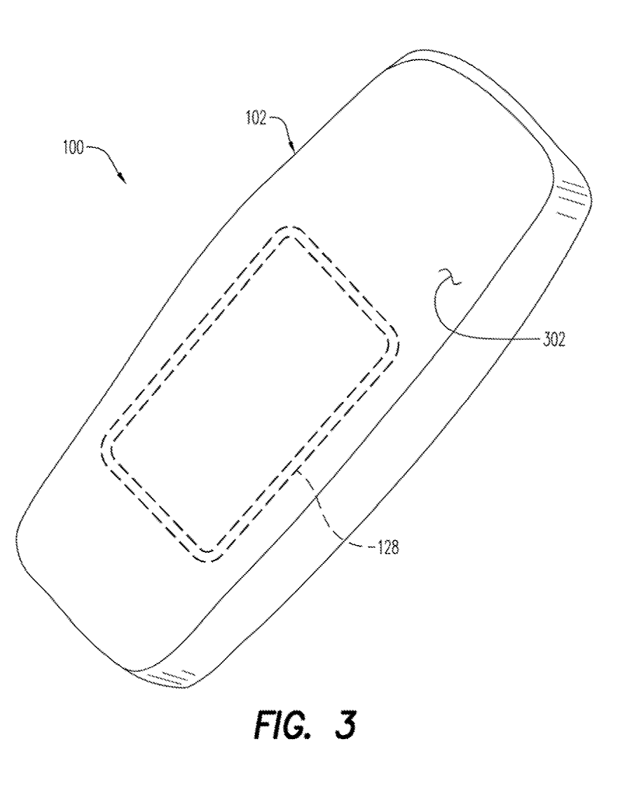

FIG. 3 is an isometric rear view of the mobile telephone/contactless payment device 100, showing the locus of the antenna 128. The antenna 128 is adjacent the rear surface 302 of the housing 102 of the mobile telephone/contactless payment device 100; accordingly, the antenna 128 may be referred to as the “rear side antenna”.

As seen from FIGS. 2 and 3, the antennas 126, 128 may both be loop antennas.

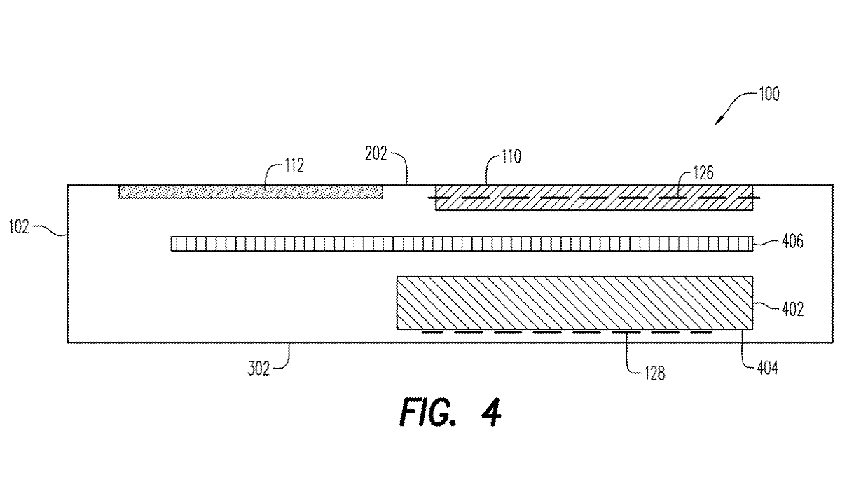

In some embodiments, the front side antenna 126 may loop around the keypad 110; this arrangement may, for example, be accomplished as in U.S. published patent application no. 2007/0024509 (Lee) or U.S. published patent application no. 2007/0057852 (Leizerovich et al.). In some embodiments, the rear side antenna 128 may be mounted on a battery (reference numeral 402, FIG. 4); this arrangement may, for example, be accomplished as in U.S. Pat. No. 7,202,825 (also Leizerovich et al.).

FIG. 4 is a schematic cross-sectional view showing some of the salient components of the mobile telephone/contactless payment device 100. The above-mentioned battery 402 is mounted adjacent the rear surface 302 of the housing 102 of the mobile telephone/contactless payment device 100, with the rear side antenna 128 mounted on the outer side 404 of the battery 402 and inside the housing 102, adjacent the rear surface 302 of the housing 102. (The battery 402 may supply power to components of the mobile telephone/contactless payment device 100, such as the receive/transmit circuitry 116 and the display 112.) The front side antenna 126 is shown inside the housing 102 and looping around the keypad 110 adjacent the front surface 202 of the housing 102. Also shown in FIG. 4 is a circuit board 406, which may include, for example, the above-mentioned receive/transmit circuitry 116 (FIG. 1, not separately shown in FIG. 4) and the above-mentioned payment circuit 124 (FIG. 1, not separately shown in FIG. 4). To simplify the drawing, connections among the components are not shown.

The antennas 126, 128 may be mounted in other manners than those referred to above. For example, either or both antennas may be embedded in the housing 102 near the front surface 202 and the rear surface 302, respectively.

The payment circuit 124 may use either or both of the antennas 126, 128 to send and/or receive information required for contactless payments. For example, and without limitation: (A) The payment circuit 124 may transmit a payment card account number (stored in the payment circuit 124) via the rear side antenna 128 when the mobile telephone/contactless payment device 100 is tapped back-to-back with another mobile device (merchant's device) in the case of a mobile-to-mobile contactless payment; or (B) the payment circuit 124 may receive a customer's payment card account number via the front side antenna 126 on an occasion when the mobile telephone/contactless payment device 100 is being used as a merchant's device and the customer's contactless payment card is tapped on the front surface 202 of the housing 102 of the mobile telephone/contactless payment device 100; or (C) the payment circuit 124 may receive a customer's payment card account number via the rear side antenna 128 on an occasion when the mobile telephone/contactless payment device 100 is being used as a merchant's device and the customer taps his/her mobile device back-to-back with the mobile telephone/contactless payment device 100 to effect a mobile-to-mobile contactless payment. In example transactions (A) and (C), the customer and the merchant may both be able to view the displays (reference numeral 112, FIG. 4, in the case of the mobile telephone/contactless payment device 100) of their respective devices as the transaction takes place so that both parties may see any relevant message presented via his/her respective mobile device. In example transaction (B), the customer and the merchant (the latter being the user/owner of the mobile telephone/contactless payment device 100) are able to view the display 112 during the transaction so that both may see any relevant message presented via the display 112.

Thus the presence of both front and rear antennas coupled to the payment circuit increases the versatility and convenience of the mobile telephone/contactless payment device 100 for use in contactless payments, and particularly when the mobile telephone/contactless payment device 100 is to be used as a merchant's device to accept contactless payments from both other mobile devices and from contactless payment cards or other contactless payment devices that are not mobile devices.

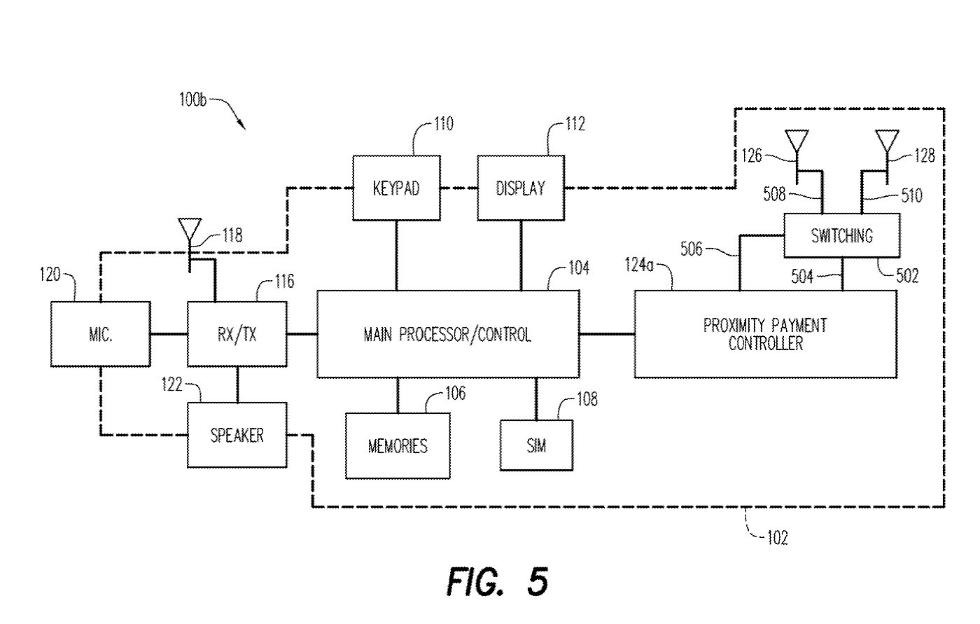

FIG. 5 is a schematic block diagram of an alternative embodiment of the mobile telephone/contactless payment device, indicated generally by reference numeral 100a. The mobile telephone/contactless payment device 100a of FIG. 5 is generally similar to the mobile telephone/contactless payment device 100 shown in FIGS. 1-4; accordingly, only the differences between the two embodiments will be described with reference to FIG. 5.

The payment circuit 124a shown in FIG. 5, and included in the mobile telephone/contactless payment device 100a, may have the same functionality as the payment circuit 124 described above in connection with FIG. 1, and also may have additional functionality as described below. The mobile telephone/contactless payment device 100a may have the same front side antenna 126 and rear side antenna 128 as the mobile telephone/contactless payment device 100, but in the case of the mobile telephone/contactless payment device 100a, the antennas 126, 128 may not be directly coupled to the payment circuit 124a. Rather, the mobile telephone/contactless payment device 100a may also include a switching circuit 502 that operates to selectively couple the payment circuit 124a to either one of the antennas 126, 128. The payment circuit 124a is coupled to the switching circuit 502 by a receive and/or transmit signal path 504 and by a control signal path 506. The switching circuit 502 is coupled to the antennas 126, 128 at 508 and 510, respectively.

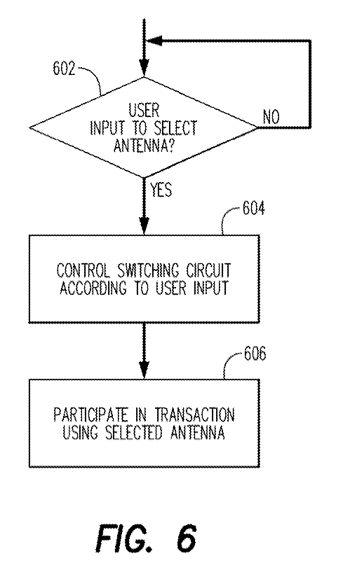

FIG. 6 is a flow chart that illustrates a process that may be performed by the mobile telephone/contactless payment device 100a in accordance with aspects of the present invention.

At 602 in FIG. 6, it is determined whether the user has provided input (e.g., via keypad 110 or via a touch screen), to indicate which one of antennas 126, 128 is to be used for a transaction that involves contactless payment. If such an input is received, then step 604 follows 602. At 604, the payment circuit 124a controls the switching circuit 502 (via control signal path 506), in accordance with the user input, to select one of the antennas 126, 128 to be coupled to the payment circuit 124a. Thus, if the user input indicates that the front side antenna 126 is to be used, then the payment circuit 124a responds to the user input by controlling the switching circuit 502 to operatively couple the antenna 126 to the payment circuit 124a. If the user input indicates that the rear side antenna 128 is to be used, then the payment circuit 124a responds to the user input by controlling the switching circuit 502 to operatively couple the antenna 128 to the payment circuit 124a.

Next, at 606, the payment circuit 124a uses the selected one of antennas 126, 128 to participate in a contactless payment transaction. That is, the payment circuit 124a uses the selected antenna 126 or 128 either to receive a customer's payment card account number (where the mobile telephone/contactless payment device 100 is being used as a merchant device), or to transmit a payment card account number that is stored in the payment circuit 124a for use in purchases by the user of the mobile telephone/contactless payment device 100.

In the case where the mobile telephone/contactless payment device 100 is being used as a merchant device, the payment circuit 124a and the receive/transmit circuitry 116 may cooperate to transmit the customer's payment card account number (received via the selected antenna 126, 128) via the antenna 118 to an acquirer financial institution in connection with a purchase transaction authorization request initiated by the mobile telephone/contactless payment device 100 in a payment system.

In either or both of the embodiments of the mobile telephone/contactless payment device as described above, the control device 104 and the payment circuit 124 or 124a may be combined in a single IC or in a chip set, or functions may be divided between the control device 104 and the payment circuit 124 or 124a in a manner other than as described hereinabove.

Instead of or in addition to the keypad 110 and/or the display 112, the mobile telephone/contactless payment device may include a touch screen.

As used in the appended claims, the term “contactless payment functionality” refers to an ability to serve as either one or both of a customer's device and a merchant's device in connection with contactless payments. Thus a device that can serve as a customer's contactless payment device but not as a merchant's, a device that can serve as a merchant's contactless payment device but not as a customer's, and a device that can serve as both a customer's and a merchant's contactless payment device all have contactless payment functionality.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A mobile telephone having contactless payment functionality, the mobile telephone comprising:
a housing having a front surface and a rear surface that is opposite to the front surface;
a microphone mounted in or on the housing;
a speaker mounted in or on the housing:
a first antenna mounted in or on the housing;
mobile telephone receive/transmit circuitry mounted in the housing; the mobile telephone receive/transmit circuitry coupled to the microphone, the speaker and the first antenna; the mobile telephone receive/transmit circuitry operative to:
transmit, via the first antenna, voice signals generated by the microphone; and
reproduce, via the speaker, voice signals received via the first antenna;
a touch screen or keypad mounted at the front surface of the housing;
a second antenna adjacent the front surface of the housing;
a third antenna adjacent the rear surface of the housing; and
a payment circuit mounted in the housing and coupled to the second and third antennas, the payment circuit operative to receive a customer's payment card account number, via one or both of the second and third antennas.

2. The mobile telephone of claim 1, wherein said second and third antennas are loop antennas.

3. The mobile telephone of claim 2, wherein:
the mobile telephone includes a keypad mounted at the front surface of the housing; and
the second antenna loops around the keypad.

4. The mobile telephone of claim 2, wherein:
the mobile telephone includes a battery mounted adjacent the rear surface of the housing, the battery for supplying power to the mobile telephone receive/transmit circuitry; and
the third antenna is mounted on the battery.

5. The mobile telephone of claim 1, wherein:
the payment circuit is coupled to the mobile telephone receive/transmit circuitry; and
the payment circuit and the mobile telephone receive/transmit circuitry selectively cooperate to transmit a purchase transaction authorization request via the first antenna, the purchase transaction authorization request including the customer's payment card account number received via one or both of the second and third antennas.

6. The mobile telephone of claim 1, further comprising:
a display mounted at the front surface of the housing.

7. The mobile telephone of claim 1, wherein the payment circuit stores a payment card account number and is operative to selectively transmit the stored payment card account number, via one or both of the second and third antennas, in response to receiving an interrogation signal from a merchant device.

8. A mobile telephone having contactless payment functionality, the mobile telephone comprising:
a housing having a front surface and a rear surface that is opposite to the front surface;
a microphone mounted in or on the housing;
a speaker mounted in or on the housing:
a first antenna mounted in or on the housing;
mobile telephone receive/transmit circuitry mounted in the housing; the mobile telephone receive/transmit circuitry coupled to the microphone, the speaker and the first antenna; the mobile telephone receive/transmit circuitry operative to:
transmit, via the first antenna, voice signals generated by the microphone; and
reproduce, via the speaker, voice signals received via the first antenna;
a touch screen or keypad mounted at the front surface of the housing;
a second antenna adjacent the front surface of the housing;
a third antenna adjacent the rear surface of the housing;
a payment circuit mounted in the housing; and
a switching circuit coupled to the payment circuit and to the second and third antennas for selectively coupling the payment circuit to a selected one of the second and third antennas;
the payment circuit operative to receive a customer's payment card account number, via the selected one of the second and third antennas.

9. The mobile telephone of claim 8, wherein:
the switching circuit is coupled to the touch screen or keypad and is responsive to user input received via the touch screen or keypad to select one of the second and third antennas to be coupled to the payment circuit.

10. The mobile telephone of claim 8, wherein said second and third antennas are loop antennas.

11. The mobile telephone of claim 10, wherein:
the mobile telephone includes a keypad mounted at the front surface of the housing; and
the second antenna loops around the keypad.

12. The mobile telephone of claim 10, wherein:
the mobile telephone includes a battery mounted adjacent the rear surface of the housing, the battery for supplying power to the mobile telephone receive/transmit circuitry; and
the third antenna is mounted on the battery.

13. The mobile telephone of claim 8, wherein:
the payment circuit is coupled to the mobile telephone receive/transmit circuitry; and
the payment circuit and the mobile telephone receive/transmit circuitry selectively cooperate to transmit a purchase transaction authorization request via the first antenna, the purchase transaction authorization request including the customer's payment card account number received via the selected one of the second and third antennas.

14. The mobile telephone of claim 8, further comprising:
a display mounted at the front surface of the housing.

15. The mobile telephone of claim 8, wherein the payment circuit stores a payment card account number and is operative to selectively transmit the stored payment card account number, via one or both of the second and third antennas, in response to receiving an interrogation signal from a merchant device.

16. A method of operating a mobile telephone, the method comprising:
receiving antenna selection input from a user of the mobile telephone; and
selecting an antenna for connection to a payment circuit in response to the antenna selection input, the antenna selected from among a plurality of antennas including a front side antenna and a rear side antenna, the front side antenna adjacent a front side of the mobile telephone, the rear side antenna adjacent a rear side of the mobile telephone, the payment circuit operative to selectively receive a customer's payment card account number via the selected antenna.

17. The method of claim 16, wherein the antenna selection input is received via a keypad.

18. The method of claim 16, wherein the antenna selection input is received via a touch screen.

19. The method of claim 16, wherein the front side antenna and the rear side antenna are loop antennas.

20. The method of claim 16, further comprising:
transmitting the customer's payment card account number via an antenna other than the front side antenna and the rear side antenna.
